(19) United States
(12) Patent Application Publication
(10) Pub. No.: US 2005/0064243 A1
(43) Pub. Date: Mar. 24, 2005

(54) Magnetic recording medium

(75) Inventors: Kenichi Moriwaki, Kanagawa (JP); Kazuyuki Usuki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/942,970

(22) Filed: Sep. 17, 2004

(30) Foreign Application Priority Data
Sep. 18, 2003 (JP) P.2003-326200

(51) Int. Cl. G11B 5/64; G11B 5/65

(52) U.S. Cl. 428/694 TR; 428/336; 428/331; 428/694 TS

(57) ABSTRACT

A magnetic recording medium comprising a substrate, an underlayer, an intermediate layer, and a magnetic layer in this order, the underlayer being made of Ru, the intermediate layer being made of an RuCo alloy, and the magnetic layer having a granular structure made up of a Co-containing ferromagnetic metal alloy and a non-magnetic oxide.

### FIELD OF THE INVENTION

This invention relates to a magnetic recording medium for digital information storage.

### BACKGROUND OF THE INVENTION

Recent popularization of the internet has diversified the use of personal computers, including processing large volumes of moving image or sound data. With this trend, the demand for magnetic recording media, such as hard disks, with increased memory capacity has ever been increasing.

In a hard disk drive, a magnetic disk is magnetized (recorded) with a magnetic head which flies from the magnetic disk by several micrometers on rotation of the magnetic disk. Thus, the magnetic head is prevented from coming into contact with the disk (head crash) and damaging the disk during high-speed rotation. The flying height of the magnetic head has been decreasing with the increasing recording density. Today, a flying height as small as 10 to 20 nm has been realized by using a magnetic disk having a magnetic layer on a super smooth and mirror-polished glass substrate. In a recording medium, a combination of a CoPtCr-based magnetic layer and a Cr-based underlayer is usually used. When formed in a high temperature of 200° C. to 500° C., the CoPtCr-based magnetic layer is controlled by the Cr-based underlayer so that the easy magnetization direction may be in-plane. Further, segregation of Cr in the CoPtCr-based magnetic layer is promoted to separate magnetic domains in the magnetic layer. Such technological innovation including reduction of head flying height, improvement on head structure, and improvement on disk recording film has brought about drastic increases of longitudinal recording density and recording capacity of a hard disk drive in these few years.

The increase of digital data that can be handled has created the need to store a large volume of data such as moving image data in a removable medium and to transfer the stored data to other media. Because of its rigidity and so small distance from the head, a hard disk cannot be used as a removable medium like a flexible disk or a rewritable optical disk on account of high possibility of troubles due to crashes or dust entrapment during rotation.

High-temperature sputtering techniques for film formation are low in productivity and costly in large volume manufacturing of recording media, resulting in uncompetitive prices.

On the other hand, a flexible disk, the substrate of which is a flexible polymer film and which is a medium capable of contact recording and reproduction, enjoys exchangeability and can be manufactured at lower cost. However, currently available flexible disks are particulate media obtained by coating a polymer base film with a coating composition containing magnetic powder, a binder resin, an abrasive, etc. and are therefore inferior in high-density recording performance. The highest recording density reachable by flexible disks is not higher than one-tenth of that of hard disks.

It has been suggested to form a magnetic layer on a flexible polymer substrate by sputtering in the same manner as in the production of a hard disk. However, the resulting flexible disk is impractical because the polymer film substrate is seriously damaged by heat in sputtering. To overcome this problem, using a heat-resistant polymer, such as polyimide or aromatic polyamide, as a substrate has been proposed, but the attempt is difficult to implement on account of the high cost of these heat-resistant polymer films. If a magnetic layer is formed on a polymer film in its cooled state to avert thermal damage, the resulting magnetic layer will have insufficient magnetic characteristics, resulting in a failure to improve recording density.

It has come to be known that a ferromagnetic metal thin film comprising a ferromagnetic metal alloy and a non-magnetic oxide which is formed on an Ru-containing underlayer at room temperature exhibits substantially the same magnetic characteristics as by a CoPtCr-based magnetic layer formed under a high temperature (200 to 500° C.) condition as disclosed in JP-A-2001-291230. Such a ferromagnetic metal thin film comprising a ferromagnetic metal alloy and a non-magnetic oxide has a so-called granular structure as is proposed for hard disks. Among this kind of magnetic layers are those specified in JP-A-5-73880 and JP-A-7-311929. Where the thin film is formed at room temperature, however, it is difficult to form an underlayer with high crystallinity and to provide a good match in lattice constant between Ru in the underlayer and Co in the magnetic layer. Therefore, this kind of a magnetic recording medium cannot be said to achieve sufficient S/N characteristics in reproducing high-density recordings.

Recordable or rewritable optical disks represented by DVD-Rs/RWs have been widely spread for their excellent exchangeability because the disks are not brought so close to a head as magnetic disks. However, it is impractical for these optical disks to have a high-capacity double-sided structure like a two-sided magnetic disk in view of the thickness of a light pickup and cost. Furthermore, an optical disk has a lower longitudinal recording density and a lower speed of data transfer than a magnetic disk and is therefore not seen as having sufficient performance, taking into consideration applicability as a rewritable high-capacity recording medium.

A high-capacity rewritable and removable recording medium that is satisfactory in characteristics, reliability, and cost performance has not been developed despite of the high demand therefor.

### SUMMARY OF THE INVENTION

An object of the present invention is to provide a high-capacity magnetic recording medium that is inexpensive and yet excellent in performance and reliability by forming an underlayer, an intermediate layer, and a magnetic layer at room temperature in that order.

The above object of the invention is accomplished by a magnetic recording medium (preferably, a longitudinal magnetic recording medium) having a substrate, an underlayer, an intermediate layer, and a magnetic layer in the order described. The underlayer is made of Ru, and the intermediate layer is made of an RuCo alloy. The magnetic layer has a granular structure made up of a Co-containing ferromagnetic metal alloy and a non-magnetic oxide.

In a preferred embodiment of the magnetic recording medium, a flexible polymer is used as the substrate.

The present invention provides a highly reliable magnetic recording medium (preferably, longitudinal magnetic recording medium) in which the ferromagnetic grains are surely in-plane oriented with reduced interaction between themselves, which is fit for high density magnetic recording device, and which can be produced by economical room temperature deposition.

### DETAILED DESCRIPTION OF THE INVENTION

Having an Ru under layer and a magnetic layer with a granular structure (hereinafter sometimes referred to as a granular magnetic layer) made of a Co-containing ferromagnetic metal alloy and a non-magnetic oxide, the magnetic recording medium of the invention is capable of high density and high capacity recording like a hard disk even though the layers are formed by room temperature deposition.

The RuCo intermediate layer interposed between the underlayer and the magnetic layer brings about improved lattice matching between Ru of the underlayer and Co of the magnetic layer.

Improved lattice matching results in increase of the Co in-plane magnetization component in the magnetic layer, which leads to in-plane crystal magnetic anisotropy enhancement and increased coercive force. As a result, the reproduced signal intensity increases, and distortion of a reproduced waveform due to the perpendicular magnetization component reduces. Thus, the magnetic recording medium of the invention is suited to high density recording.

The magnetic recording medium of the invention preferably has a coercive force Hc of 230 to 330 kA/m, still preferably 250 to 320 kA/m, in an in-plane direction and a squareness of 0.6 to 0.8 in an in-plane direction. The term “in-plane direction” as used herein means an arbitrary direction parallel to the magnetic layer surface.

The magnetic recording medium of the invention can be produced by room temperature film formation. That is, the substrate does not need to be heated. Even if the substrate is at room temperature, a magnetic recording medium providing satisfactory S/N characteristics in high-density recording can be obtained. This means that not only a glass or aluminum substrate but a polymer base film can be used as a substrate of deposition without undergoing thermal damages thereby to provide a flat magnetic tape or a flexible disk withstanding contact recording and reproduction.

As stated above, the substrate that can be used includes a flexible polymer film as well as an aluminum sheet and a glass sheet. A flexible polymer film is preferred for productivity. The magnetic recording medium having a polymer base film includes a tape and a flexible disk. A flexible disk having a polymer base film has a hub hole in the center and is enclosed in a plastic shell or jacket. The shell usually has a head access window covered with a metal piece called a shutter. A magnetic head access is allowed through the access window to carry out recording and reproduction of signals.

While the magnetic recording medium of the present invention will be described in more detail with particular reference to a flexible disk, the description applies to a magnetic recording tape as well.

A flexible disk of the invention has an underlayer, an intermediate layer, and a magnetic layer in that order formed on each side of a disk-shaped polymer film substrate. The flexible disk preferably has an undercoating layer for improving surface properties and gas barrier properties, a gas barrier layer functioning for adhesion and gas barrier, an underlayer, an intermediate layer, a magnetic layer, a protective layer protecting the magnetic layer against corrosion and wear, and a lubricating layer for improving running durability and anticorrosion formed on the substrate in the order described.

As set forth above, the magnetic layer is a granular magnetic layer in which the Co-containing ferromagnetic metal alloy and the non-magnetic oxide are macroscopically in a mixed state but, when microscopically observed, nanometer-sized ferromagnetic alloy grains (usually about 1 to 110 nm) are surrounded by the non-magnetic oxide. The granular structure achieves high coercivity and assures a narrow distribution of magnetic particle size, thus providing a low noise medium.

The Co-containing ferromagnetic metal alloy is an alloy of cobalt with other elements including Cr, Pt, Ni, Fe, B, Si, Ta, Nb, and Ru. From the standpoint of recording characteristics, preferred are Co—Pt—Cr, Co—Pt—Cr—Ta, Co—Pt—Cr—B, and Co—Ru—Cr.

The non-magnetic oxide that can be used in the invention includes an oxide of Si, Zr, Ta, B, Ti, Al, Cr, Ba, Zn, Na, La, In, Pb, etc. From the viewpoint of recording characteristics, an oxide of silicon (SiOₓ) is the most preferred.

The molar ratio of the Co-containing ferromagnetic metal alloy to the non-magnetic oxide preferably ranges from 95:5 to 80:20, still preferably 90:10 to 85:15. With the ratio falling within that range, the magnetic grains are sufficiently isolated from each other to provide high coercivity, and the magnetization will be assured to secure signal output.

The granular magnetic layer preferably has a thickness of 5 to 60 nm, still preferably 5 to 30 nm. Within that thickness range, the interaction between columnar magnetic particles due to grain growth is suppressed, which promises reduced noise and increased output.

The granular magnetic layer can be formed by vacuum deposition techniques, such as evaporation and sputtering. Sputtering is suitable for ease in forming an ultrathin film with good quality. Sputtering is carried out by DC sputtering, RF sputtering, etc. A roll-to-roll or web sputtering system in which a continuous web is treated is advantageous. A batch sputtering system or an in-line sputtering system as adopted in the production of hard disks is also useful.

As usual, argon gas can be used as a sputtering gas. Other rare gases are also employable. The sputtering gas may contain a trace amount of oxygen gas for the purpose of adjusting the oxygen content of the non-magnetic oxide or oxidizing the surface of the magnetic layer.

It is possible to carry out co-sputtering using a ferromagnetic metal alloy and a non-magnetic oxide as separate targets to form the granular magnetic layer comprising the Co-containing ferromagnetic metal alloy and the non-magnetic oxide. It is preferred, nevertheless, to use an alloy target containing the Co-containing ferromagnetic metal alloy and the non-magnetic oxide so as to improve the magnetic grain size distribution thereby to form a homogeneous film. The alloy target is prepared by hot pressing.

The argon pressure in the sputtering is preferably 5 to 100 mTorr (0.7 to 13.3 Pa), still preferably 10 to 50 mTorr (1.3 to 6.7 Pa) to secure crystallinity of the magnetic layer and sufficiently separate the magnetic particles from each other thereby controlling the interaction between magnetic particles and obtaining satisfactory magnetic characteristics. As a result, low-noise, high-strength, and highly reliable magnetic recording medium can be provided.

The power density for sputtering preferably ranges from 1 to 100 W/cm², more preferably 2 to 50 W/cm², for obtaining crystallinity and film adhesion and preventing the substrate from being deformed and cracks from developing in the magnetic layer.

An underlayer is provided to control the crystal orientation of the magnetic layer. The Ru underlayer according to the present invention meets this purpose because an Ru film exhibits high crystallinity even when deposited at room temperature.

The underlayer preferably has a thickness of 5 to 100 nm, still preferably 5 to 50 nm. With the underlayer thickness falling within that range, improvement on magnetic characteristics is ensured while obtaining satisfactory productivity, growth of the crystal grains, which can cause noise, is prevented, and film resistance to the stress imposed on head contact is provided to secure running durability.

The underlayer can be formed by vacuum deposition techniques, such as evaporation and sputtering. Sputtering is particularly suitable for forming a good quality ultrathin film with ease. Sputtering is carried out by DC sputtering, RF sputtering, etc. A roll-to-roll sputtering system in which a continuous web is treated is suited to produce flexible disks having a flexible polymer film as a substrate. A batch sputtering system and an in-line sputtering system as adopted for film formation on an aluminum or glass substrate are also usable.

As usual, argon gas can be used as a sputtering gas. Other rare gases are also employable. The sputtering gas may contain a trace amount of oxygen gas for the purpose of controlling lattice constant of the underlayer.

The argon gas pressure in the sputtering is preferably 5 to 100 mTorr (0.7 to 13.3 Pa), still preferably 10 to 50 mTorr (1.3 to 6.7 Pa) to properly control the energy possessed by the sputtered particles, suppress the perpendicular Ru component, and ensure Ru crystallinity. As a result, the film stress is reduced to prevent the flexible substrate from being deformed, and the crystal orientation in the magnetic layer is secured to provide a highly reliable magnetic recording medium.

The RuCo alloy intermediate layer is provided for the purpose of making a lattice match between Ru in the underlayer and Cu in the magnetic layer. The Ru to Co atomic ratio of the alloy is preferably 80:20 to 40:60, more preferably 70:30 to 40:60. At the recited Ru:Co ratio, the lattice constant can be approximated to the cobalt's of the magnetic layer, whereby the crystal orientation of the magnetic layer is improved. Having no magnetism, the intermediate layer does not impair the high density recording/reproduction characteristics.

The thickness of the intermediate layer is preferably 1 to 60 nm, still preferably 3 to 30 nm. Within that range, the productivity is maintained, and the interaction between columnar structures due to grain growth is suppressed, which suppresses increase of noise. Besides, that thickness allows the intermediate layer to exhibit its maximum effects on lattice matching.

The intermediate layer can be formed by vacuum deposition techniques, such as evaporation and sputtering. Sputtering is suitable for ease in forming an ultrathin film with good quality. Sputtering is carried out by DC sputtering, RF sputtering, etc. A roll-to-roll sputtering system in which a continuous web is treated is advantageous. A batch sputtering system or an in-line sputtering system as adopted in the production of hard disks is also useful.

As usual, argon gas can be used as a sputtering gas. Other rare gases are also employable. The sputtering gas may contain a trace amount of oxygen gas.

It is possible to carry out co-sputtering using an Ru target and a Co target to form the RuCo alloy layer. It is preferable, nevertheless, to use an RuCo alloy target so as to improve the grain distribution thereby to form a homogeneous film. The alloy target is prepared by hot pressing.

A seed layer may be provided between the underlayer and the substrate for the purpose of controlling the crystal orientation of the underlayer. Materials for such a seed layer desirably include, but are not limited to, Ti-, W- or V-based alloys.

The seed layer preferably has a thickness of 1 to 30 nm to secure productivity and to control growth of crystal grains thereby suppressing noise increase. The seed layer can be formed by vacuum deposition techniques, such as evaporation and sputtering. Sputtering is suitable for ease in forming a good quality, ultrathin film.

A gas barrier layer is preferably provided between the substrate and the underlayer for improving adhesion and providing gas barrier protection. Where both the seed layer and the gas barrier layer are formed, the gas barrier layer is preferably formed between the seed layer and the substrate. The gas barrier layer can be of a non-metallic single substance, a mixture of such single substances, or a Ti compound with a non-metallic element. These materials are resistant against the stress imposed on head contact.

The thickness of the gas barrier layer is preferably 5 to 200 nm, still preferably 5 to 100 nm, to secure productivity and to control growth of crystal grains thereby suppressing noise increase. The gas barrier layer can be formed by vacuum deposition techniques, such as evaporation and sputtering. Sputtering is suitable for ease in forming a good quality, ultrathin film.

The substrate is preferably a flexible polymer film for avoiding the shocks on contact between the magnetic disk and a magnetic head. Useful flexible polymers include aromatic polyimide, aromatic polyamide, aromatic polyamide-imide, polyether ketone, polyether sulfone, polyether imide, polysulfone, polyphenylene sulfide, polyethylene naphthalate, polyethylene terephthalate, polycarbonate, cellulose triacetate, and fluorine resins. Since satisfactory recording characteristics can be achieved without heating the substrate in vacuum deposition, polyethylene terephthalate or polyethylene naphthalate is preferred for their low cost and satisfactory surface properties.

A laminated film composed of polymer films of the same or different kinds may be used as a substrate. Such a laminated film is less susceptible to warpage or waviness per se, which eventually eliminates warpage or waviness of the resulting flexible disk and markedly reduces scratches of the magnetic layer.

Laminating is carried out by hot roll lamination or hot press lamination, or with an adhesive. The adhesive may be applied directly to an adherent or transferred from a release sheet to an adherent. The adhesive is not particularly limited and includes ordinary hot-melt adhesives, thermosetting adhesives, UV curing adhesives, EB curing adhesives, pressure-sensitive adhesive sheets, and anaerobic adhesives.

The thickness of the substrate is preferably 10 to 200 μm, still preferably 20 to 150 μm, particularly preferably 30 to 100 μm. Within that thickness range, the disk shows high-speed spinning stability, namely, reduced axial runout, and the rigidity of the disk can be kept low to absorb the shock on contact with a magnetic head thereby to prevent the head from jumping up.

The stiffness of the flexible substrate is represented by Ebd³/12, wherein E is a Young's modulus; b is a film width; and d is a film thickness. With the film width b set at 10 mm, the Ebd³/12 is preferably 0.5 to 2.0 kgf/mm² (4.9 to 19.6 MPa), still preferably 0.7 to 1.5 kgf/mm² (6.9 to 14.7 MPa).

It is desirable that the surface of the substrate be as smooth as possible for recording with a magnetic head. Surface roughness of the substrate significantly influences the signal recording and reproduction characteristics. Specifically, a substrate on which an undercoating layer described later is to be provided preferably has a centerline average roughness Ra of 5 nm or smaller, particularly 2 nm or smaller, as measured with an optical profilometer and a projection height of 1 μm or smaller, particularly 0.1 μm or smaller, as measured with a stylus type profilometer. A substrate on which an undercoating layer is not to be provided preferably has a centerline average roughness Ra of 3 nm or smaller, particularly 1 nm or smaller as measured with an optical profilometer and a projection height of 0.1 μm or smaller, particularly 0.06 μm or smaller, as measured with a stylus type profilometer.

It is preferred to provide an undercoating layer on the magnetic layer side of the substrate for improving surface smoothness and gas barrier properties. Since the magnetic layer is formed by sputtering or a like deposition technique, the undercoating layer is preferably resistant to heat. Useful materials for forming the undercoating layer include polyimide resins, polyamide-imide resins, silicone resins, and fluorine resins. Thermosetting polyimide resins and thermosetting silicone resins are particularly preferred for their high smoothing effect. The undercoating layer preferably has a thickness of 0.1 to 3.0 μm. Where a laminated film is used as a flexible substrate, the undercoating layer may be formed either before or after the lamination.

Suitable thermosetting polyimide resins include those obtained by thermal polymerization of an imide monomer containing at least two unsaturated end groups per molecule, such as Bis-allyl-nadi-imide (BANI) series available from Maruzen Petrochemical Co., Ltd. This series of imide monomers are allowed to be applied to the substrate and then thermally polymerized (set) at relatively low temperatures on the substrate. Further, they are soluble in universal solvents, which is advantageous for productivity and workability. Furthermore they have a low molecular weight to provide a low viscosity monomer solution, which easily fills up surface depressions to produce high leveling performance.

Suitable thermosetting silicone resins include those prepared by a sol-gel method starting with an organic group-containing silicon compound. Silicone resins of this type have a structure of silicon dioxide with part of its bonds substituted with an organic group. Much more heat-resistant than silicone rubbers and more flexible than a silicon dioxide film, they are capable of forming such a resin film on a flexible substrate that will hardly suffer from cracks or peel. Since the monomer of these silicone resins is allowed to be applied directly to the substrate followed by setting, universal solvents are employable to prepare a monomer solution, which easily fills up surface depressions to produce high leveling performance. In addition, the monomer solution can be designed to start polycondensation reaction from relatively low temperatures by addition of a catalyst, such as an acid or a chelating agent. That is, the curing reaction completes in a short time, which enables use of a general-purpose coating apparatus to form a resin film. Furthermore, the thermosetting silicone resin exhibits high barrier properties against gases which may generate from the substrate during recording layer formation and hinder the crystallinity and orientation of the recording layer or the underlayer.

For the purpose of reducing the true contact area between the head and the disk thereby to improve sliding properties, it is preferred to provide the surface of the undercoating layer with micro projections. A substrate having such a textured undercoating layer will have improved handling properties. Micro projections can be formed by, for example, applying spherical silica particles or an emulsion of organic powder. In order to secure heat resistance of the undercoating layer, application of spherical silica particles is preferred.

The micro projections preferably have a height of 5 to 60 nm, still preferably 10 to 30 nm. Too high micro projections result in increased spacing loss between the head and the medium, which deteriorates recording and reproduction characteristics. Too low micro projections produce insubstantial effects in improving sliding characteristics. The density of the micro projections is preferably 0.1 to 100/μm², still preferably 1 to 10/μm². At too small a micro projection density, the sliding properties improving effects are insubstantial. Too high a micro projection density can cause the applied fine particles to agglomerate into unfavorably high projections.

It is possible to fix the micro projections to the substrate surface with a binder resin. The binder resin is preferably selected from those with sufficient heat resistance, such as solvent-soluble polyimide resins, thermosetting polyimide resins, and thermosetting silicone resins.

The protective layer protects metallic materials of the magnetic layer against corrosion and prevents wear of the magnetic disk due to pseudo-contact or sliding contact with a magnetic head thereby improving running durability and anticorrosion. Materials for forming the protective layer include oxides, such as silica, alumina, titania, zirconia, cobalt oxide, and nickel oxide; nitrides, such as titanium nitride, silicon nitride, and boron nitride; carbides, such as silicon carbide, chromium carbide, and boron carbide; and carbonaceous materials, such as graphite and amorphous carbon.

The protective layer preferably has the same or higher hardness than the magnetic head and a stable, long-lasting anti-seizure effect during sliding for exhibiting excellent sliding durability. From the standpoint of anticorrosion, the protective layer is preferably free from pinholes. Among such protective layers is a hard carbon film called diamond-like carbon (DLC) formed by RF plasma enhanced CVD, ion beam deposition, electron cyclotron resonance (ECR), etc.

The protective layer can have a multilayer structure, i.e., a stack of two or more thin films having different properties. For example, a dual-layer protective layer having a DLC film on the outer side for improving sliding characteristics and a nitride layer (e.g., silicon nitride) on the inner side for improving anticorrosion will promise high levels of anticorrosion and durability.

A lubricating layer can be provided on the protective layer for improving running durability and anticorrosion. The lubricating layer contains known lubricants, such as hydrocarbon lubricants, fluorine lubricants, and extreme pressure additives.

The hydrocarbon lubricants include carboxylic acids, such as stearic acid and oleic acid; esters, such as butyl stearate, sulfonic acids, such as octadecylsulfonic acid, phosphoric esters, such as monooctadecyl phosphate; alcohols, such as stearyl alcohol and oleyl alcohol; carboxylic acid amides, such as stearamide; and amines, such as stearylamine.

The fluorine lubricants include the above-recited hydrocarbons with part or the whole of their alkyl moiety displaced with a fluoroalkyl group or a perfluoropolyether group. The perfluoropolyether group includes those derived from perfluoromethylene oxide polymers, perfluoroethylene oxide polymers, perfluoro-n-propylene oxide polymers (CF₂CF₂CF₂O)ₙ, perfluoroisopropylene oxide polymers (CF(CF₃)CF₂O)ₙ, and copolymers of these monomer units. A perfluoromethylene-perfluoroethylene copolymer having a hydroxyl group at the molecular end (Fomblin Z-DOL, available from Ausimont) is an example.

The extreme pressure additives include phosphoricesters, such as trilauryl phosphate; phosphoric esters, such as trilauryl phosphite; thiophosphoric esters, such as trilauryl trithiophosphite; thiophosphoric esters; and sulfur type ones, such as dibenzyl disulfide.

These lubricants can be used either individually or as a combination of two or more thereof. The lubricating layer is formed by applying a solution of a desired lubricant in an organic solvent to the protective layer by spin coating, wire coating, gravure coating, dip coating or like wet coating methods, or by depositing a lubricant by vacuum evaporation. The amount of the lubricant to be applied is preferably 1 to 30 mg/m², still preferably 2 to 20 mg/m².

In order to further improve anticorrosion, a combined use of a corrosion inhibitor is recommended. Useful corrosion inhibitors include nitrogen-containing heterocyclic compounds, such as benzotriazole, benzimidazole, purine, and pyrimidine, and derivatives thereof having an alkyl side chain, etc. introduced into their nucleus; and nitrogen- and sulfur-containing heterocyclic compounds, such as benzothiazole, 2-mercaptobenzothiazole, tetraazaindene compounds, and thiouracil compounds, and their derivatives. The corrosion inhibitor may be mixed into the lubricant solution to be applied to the protective layer, or may be applied to the protective layer before the lubricating layer is formed. The amount of the corrosion inhibitor to be applied is preferably 0.1 to 10 mg/m², still preferably 0.5 to 5 mg/m².

### EXAMPLES

The present invention will now be illustrated in greater detail with reference to Examples, but it should be understood that the invention is not limited thereto.

### Example 1

A coating composition for undercoating layer consisting of 3-glycidoxypropyltrimethoxysilane, phenyltriethoxysilane, hydrochloric acid, tris(acetylacetonato) aluminum, and ethanol was applied to a polyethylene naphthalate film substrate having a thickness of 63 μm and a surface roughness Ra of 1.4 nm by gravure coating and dried and cured at 100° C. to form a 1.0 μm thick undercoating layer of a silicone resin. A mixture of silica sol having a particle size of 20 nm and the coating composition for undercoating layer described above was applied to the undercoating layer by gravure coating to form micro projections having a height of 15 nm on the undercoating layer at a density of 10/μm². The undercoating layer with the micro projections was formed on both sides of the substrate. The roll of the resulting web was set in a roll-to-roll sputtering system, and the web was carried through the deposition chamber in intimate contact with a water-cooled cylindrical can. A gas barrier carbon layer was deposited on the undercoating layer by DC magnetron sputtering to a deposit thickness of 30 nm. An Ru underlayer was deposited under an argon pressure of 20 mTorr (2.7 Pa) to a thickness of 20 nm. An intermediate layer of Ru₅₀—CO₅₀ was formed under an argon pressure of 20 mTorr (2.7 Pa) to a thickness of 10 nm. A magnetic layer of (CO₇₀—Pt₂₀—Cr₁₀)₈₈—(SiO₂)₁₂ was formed under an argon pressure of 20 mTorr (2.7 Pa) to a thickness of 20 nm. The gas barrier layer, underlayer, intermediate layer and magnetic layer were each formed on both sides of the web. The coated web was set in a roll-to-roll ion beam deposition system. Ion beam deposition was carried out using a reactive gas consisting of ethylene, nitrogen and argon to deposit a nitrogen-doped DLC protective layer having a C:H:N molar ratio of 62:29:7 to a thickness of 10 nm. The protective layer was formed on each magnetic layer. A solution of perfluoropolyether lubricant Fomblin Z-DOL (from Montefluos) in a hydrofluoroether solvent (HFE-7200, from Sumitomo 3M) was applied to the protective layer by gravure coating to form a 1 nm thick lubricating layer. The lubricating layer was formed on each protective layer. The resulting coated web was punched into 3.7″ disks, and the disks were each burnished with lapping tape and put into a resin cartridge Zip 100 (from Fuji Photo Film) to prepare two-sided flexible disks.

### Example 2

The web having the undercoating layer on each side prepared in Example 1 was punched into disks of 130 mm in diameter. The disk was fixed on a circular ring holder and successively coated on each side with a gas barrier layer, an underlayer, an intermediate layer, and a magnetic layer having the same compositions as in Example 1 by batchwise sputtering. A DLC protective layer was formed on each magnetic layer in the same manner as in Example 1. A lubricating layer having the same composition as in Example 1 was formed on each protective layer by dip coating. The resulting coated disk was punched into a 3.7″ disk, which was burnished with lapping tape and put into a resin cartridge Zip 100 (from Fuji Photo Film) to prepare a flexible disk.

### Example 3

A flexible disk was produced in the same manner as in Example 1, except for increasing the intermediate layer thickness to 20 nm.

### Example 4

A flexible disk was produced in the same manner as in Example 1, except for making the intermediate layer of an RuCo alloy having a composition of Ru₆₀—CO₄₀.

### Example 5

A hard disk was produced in the same manner as in Example 2, except that the polyethylene naphthalate film having the underlayer with micro projections on each side was replaced with a mirror-polished 3.7″ glass substrate with no undercoating layer. The resulting disk was not put into a cartridge.

### Comparative Example 1

A flexible disk was produced in the same manner as in Example 1, except that the intermediate layer was not provided.

The magnetic recording media obtained in Examples 1 to 5 and Comparative Example 1 were evaluated as follows. The results obtained are shown in Table 1.

1) Magnetic Characteristics

In-plane coercive force (Hc) and in-plane squareness (SQ) were measured with a vibrating sample magnetometer.

2) Recording and Reproduction Characteristics

Signals recorded at a linear density of 400 kfci were reproduced with a giant magnetoresistive (GMR) head having a read track width of 0.25 μm and a read gap length of 0.09 μm to obtain a signal to noise ratio (SNR). The rotational speed was 4200 rpm. The position of measurement was at a radial distance of 35 mm from the center of the disk. The SNR was expressed relatively taking the result of Example 1 as a standard (0).

TABLE 1

| | Hc (kA/m) | SQ | SNR (dB) |
|---|---|---|---|
| Example 1 | 305 | 0.65 | 0 |
| Example 2 | 310 | 0.67 | +1.0 |
| Example 3 | 315 | 0.71 | +1.4 |
| Example 4 | 315 | 0.70 | +0.8 |
| Example 5 | 310 | 0.66 | 0 |
| Comparative | 220 | 0.59 | −1.6 |
| Example 1 | | | |

As can be seen from the results in Table 1, the magnetic recording medium of the present invention has high coercivity and achieves high S/N characteristics in reproducing longitudinal recordings with a GMR head. In contrast, the disk of Comparative Example 1 which does not have the RuCo intermediate layer is inferior in in-plane Hc and SQ and has reduced S/N characteristics.

This application is based on Japanese Patent application JP 2003-326200, filed Sep. 18, 2003, the entire content of which is hereby incorporated by reference, the same as if set forth at length.

1. A magnetic recording medium comprising a substrate, an underlayer, an intermediate layer, and a magnetic layer in this order, the underlayer being made of Ru, the intermediate layer being made of an RuCo alloy, and the magnetic layer having a granular structure made up of a Co-containing ferromagnetic metal alloy and a non-magnetic oxide.

2. The magnetic recording medium according to claim 1, which is a longitudinal magnetic recording medium.

3. The magnetic recording medium according to claim 1, wherein the Co-containing ferromagnetic metal alloy is an alloy of cobalt with at least one element selected from Cr, Pt, Ni, Fe, B, Si, Ta, Nb, and Ru.

4. The magnetic recording medium according to claim 1, wherein the Co-containing ferromagnetic metal alloy is an alloy of Co—Pt—Cr, Co—Pt—Cr—Ta, Co—Pt—Cr—B, or Co—Ru—Cr.

5. The magnetic recording medium according to claim 1, wherein the non-magnetic oxide is an oxide of Si, Zr, Ta, B, Ti, Al, Cr, Ba, Zn, Na, La, In, or Pb.

6. The magnetic recording medium according to claim 1, wherein the non-magnetic oxide is an oxide of silicon.

7. The magnetic recording medium according to claim 1, wherein a molar ratio of the Co-containing ferromagnetic metal alloy to the non-magnetic oxide in the granular structure is from 95:5 to 80:20:

8. The magnetic recording medium according to claim 1, wherein the magnetic layer has a thickness of 5 to 60 nm.

9. The magnetic recording medium according to claim 1, wherein the magnetic layer has a thickness of 5 to 30 nm.

10. The magnetic recording medium according to claim 1, wherein the underlayer has a thickness of 5 to 50 nm.

11. The magnetic recording medium according to claim 1, wherein the intermediate layer has a thickness of 1 to 60 nm.

12. The magnetic recording medium according to claim 1, wherein the intermediate layer has a thickness of 3 to 30 nm.

13. The magnetic recording medium according to claim 1, which further comprises a gas barrier layer so that the substrate, the gas barrier layer and the underlayer are in this order, wherein the gas barrier layer contains a non-metallic single substance or a Ti compound with a non-metallic element.

14. The magnetic recording medium according to claim 13, wherein the gas barrier layer has a thickness of 5 to 200 nm.

15. The magnetic recording medium according to claim 1, wherein the substrate is a flexible polymer substrate.

16. The magnetic recording medium according to claim 15, wherein the flexible polymer substrate has a thickness of 10 to 200 μm.

17. The magnetic recording medium according to claim 15, wherein the flexible polymer substrate has a thickness of 10 to 100 μm.

18. The magnetic recording medium according to claim 15, wherein the flexible polymer substrate contains at least one of aromatic polyimide, aromatic polyamide, aromatic polyamide-imide, polyether ketone, polyether sulfone, polyether imide, polysulfone, polyphenylene sulfide, polyethylene naphthalate, polyethylene terephthalate, polycarbonate, cellulose triacetate, and fluorine resins.

19. The magnetic recording medium according to claim 15, which further comprises an undercoating layer containing at least one of polyimide resins, polyamide-imide resins, silicone resins and fluorine resins, so that the flexible polymer substrate, the undercoating layer and the underlayer are in this order.

20. The magnetic recording medium according to claim 19, wherein the undercoating layer has, at its surface, projections having a height of 5 to 60 nm.

21. The magnetic recording medium according to claim 20, wherein a density of the projections provided on the surface of the undercoating layer is 0.1 to 100/μm².

22. The magnetic recording medium according to claim 20, wherein the projections are made by spherical silica particles.
